(19) United States
(12) Patent Application Publication
(10) Pub. No.: US 2026/0237043 A1
(43) Pub. Date: Aug. 13, 2026

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventors: Tsukasa MATSUO, Tokyo (JP); Kazumine OGURA, Tokyo (JP); Jiro ABE, Tokyo (JP); Kazuya INABA, Tokyo (JP)

(73) Assignee: NEC Corporation, Tokyo (JP)

(21) Appl. No.: 19/454,829

(22) Filed: Jan. 21, 2026

(30) Foreign Application Priority Data
Feb. 13, 2025 (JP) 2025-021262

(51) Int. Cl. G06T 7/00; G06T 7/246; G06T 7/73; G06V 10/75; G06V 20/10

(52) U.S. Cl. CPC G06T 7/0002; G06T 7/248; G06T 7/74; G06V 10/757; G06V 20/176; G06T 2207/20081; G06T 2207/30184

(57) ABSTRACT

An information processing apparatus includes an extraction unit for referring, in a case where an inspection image of a target includes an image of damage, to a structure, that is difficult to visually inspect, to a damage position included in inspection history information in which a past inspection history is stored, and extracting a past inspection image captured in a past inspection in which a distance from a position where the inspection image is captured or an inspection imaging position representing a damage position of the target to a past damage position is within a distance range set in advance, and a first calculation unit for calculating a first score based on closeness of the distance for the extracted past inspection image.

### CROSS REFERENCE TO RELATED APPLICATION

This application is based upon and claims the benefit of priority from Japanese patent application No. 2025-021262, filed on Feb. 13, 2025, the disclosure of which is incorporated herein in its entirety by reference.

### TECHNICAL FIELD

The present disclosure relates to an information processing apparatus that supports an inspection, an information processing method, and a computer-readable recording medium.

### BACKGROUND ART

The damage to the structure includes, for example, damage that is difficult to visually inspect, such as floating of concrete. In the case of the damage that is difficult to visually inspect, it is not possible to extract a sufficient feature for collation from each of an image captured at the time of inspection and an image captured at the time of past inspection.

As a related technique, Patent Literature 1 (JP 2017-102672 A) discloses a technique for performing image collation processing after narrowing down a collation image and identifying a position of a target to be inspected appearing in a target image in a short time with high accuracy. The geolocation information identifying system of JP 2017-102672 A searches for the collation image from the first database using the first database including the collation image with respect to the target image in which the target to be inspected appears, the position information of the collation image, and the attribute information of the collation image, and the narrowing condition that is the attribute information of the target to be inspected, compares the target image with the searched collation image, and extracts the collation image similar to the target image and the position information of the similar collation image from the first database.

However, in the geolocation information identifying system of JP 2017-102672 A, collation is performed using an image captured at the time of inspection and an image captured at the time of past inspection, but a case of damage, to the structure, that is difficult to visually inspect is not mentioned.

### SUMMARY

An object of the present disclosure is to support inspection in such a way as to be able to perform efficient inspection even for the damage that is difficult to visually inspect.

In order to achieve the above object, an information processing apparatus according to an aspect of the present disclosure includes an extraction unit for referring, in a case where an inspection image of a target includes an image of damage, to a structure, that is difficult to visually inspect, to a damage position included in inspection history information in which a past inspection history is stored, and extracting a past inspection image captured in a past inspection in which a distance from a position where the inspection image is captured or an inspection imaging position representing a damage position of the target to a past damage position is within a distance range set in advance, and a first calculation unit for calculating a first score based on closeness of the distance for the extracted past inspection image.

In order to achieve the above object, an information processing method according to an aspect of the present disclosure, the information processing method executed by a computer includes referring, in a case where an inspection image of a target includes an image of damage, to a structure, that is difficult to visually inspect, to a damage position included in inspection history information in which a past inspection history is stored, and extracting a past inspection image captured in a past inspection in which a distance from a position where the inspection image is captured or an inspection imaging position representing a damage position of the target to a past damage position is within a distance range set in advance, calculating a first score based on closeness of the distance for the extracted past inspection image, and generating display information for causing a display device to display a display in which the extracted past inspection image and the first score are associated with each other.

Furthermore, in order to achieve the above object, a computer-readable recording medium according to an aspect of the present disclosure, the computer-readable recording medium recording a program causes a computer to execute the steps of referring, in a case where an inspection image of a target includes an image of damage, to a structure, that is difficult to visually inspect, to a damage position included in inspection history information in which a past inspection history is stored, and extracting a past inspection image captured in a past inspection in which a distance from a position where the inspection image is captured or an inspection imaging position representing a damage position of the target to a past damage position is within a distance range set in advance, calculating a first score based on closeness of the distance for the extracted past inspection image, and generating display information for causing a display device to display a display in which the extracted past inspection image and the first score are associated with each other.

As described above, according to the present disclosure, it is possible to support inspection in such a way as to be able to perform efficient inspection even for the damage that is difficult to visually inspect.

### BRIEF DESCRIPTION OF THE DRAWINGS

FIG. 1 is a diagram for describing an example of an information processing apparatus;

FIG. 2 is a diagram illustrating an example of a system including the information processing apparatus;

FIG. 3 is a diagram for describing an example of inspection of a bridge;

FIG. 4 is a view for describing exposure of a specific member;

FIG. 5 is a diagram for describing an example of display of scores in the case of damage, to the structure, that is difficult to visually inspect;

FIG. 6 is a diagram for describing an example of display of scores in the case of damage, to a structure, that can be visually inspected;

FIG. 7 is a diagram for describing an example of the operation of the information processing apparatus;

FIG. 8 is a diagram for describing an example of the operation of the information processing apparatus; and

FIG. 9 is a diagram for describing an example of a computer that achieves the information processing apparatus according to an example embodiment.

### EXAMPLE EMBODIMENT

Hereinafter, an example embodiment will be described with reference to the drawings. In the drawings described below, elements having identical function or matching functions are denoted by identical reference signs, and repeated description thereof may be omitted.

### Example Embodiment

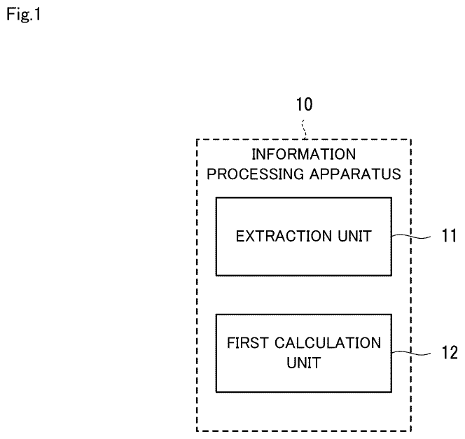

A configuration of an information processing apparatus according to the example embodiment will be described, with reference to FIG. 1. FIG. 1 is a diagram for describing an example of an information processing apparatus.

### Apparatus configuration

The information processing apparatus illustrated in FIG. 1 is a device (inspection support device) that supports inspection in such a way as to be able to perform efficient inspection even for the damage that is difficult to visually inspect. As illustrated in FIG. 1, an information processing apparatus 10 includes an extraction unit 11 and a first calculation unit 12.

In a case where an image of damage, to the structure, that is difficult to visually inspect is included in an inspection image of a target, the extraction unit 11 refers to a damage position (two-dimensional or three-dimensional coordinates) included in inspection history information in which a past inspection history is stored, and extracts a past inspection image (candidate image) captured in a past inspection in which a distance from a position where the inspection image of the target is captured or an inspection imaging position (two-dimensional or three-dimensional coordinates) representing the damage position of the target to the past damage position is within a preset distance range.

Since the inspection imaging position and the past damage position can be acquired in two-dimensional or three-dimensional coordinates, in a case where both are three-dimensional coordinates, the distance in the three-dimensional space is represented, in a case where both are two-dimensional coordinates, the distance in the two-dimensional space is represented, and in a case where one is three-dimensional and the other is two-dimensional, the distance in the two-dimensional space is represented by ignoring the height axis of the three-dimensional coordinates in advance.

The structure includes a structure constructed using a cured product (concrete, mortar, or the like), solidified using at least sand, water, and cement, or a metal, or the both. The structure is the entire building or part thereof. Further, the structure is the entire machinery or part thereof.

The damage, to the structure, that is difficult to visually inspect in the inspection image is, for example, damage that cannot be visually determined (in order to make a determination, another inspection such as a noise inspection is required) such as floating of concrete. However, the damage is not limited to floating of concrete.

The damage position represents a position (two-dimensional or three-dimensional position coordinates) of the damaged portion. Alternatively, it may be the position of the terminal device of the operator who has captured the inspection image captured during the past inspection.

The first calculation unit 12 calculates the first score for each extracted past inspection image (candidate image) based on the closeness of the distance from the inspection imaging position to the damage position.

As described above, in the example embodiment, by presenting the score of each of the extracted past inspection images (candidate images) to the operator, it is possible to perform the inspection support in such a way that the association with the past inspection result can be efficiently performed even for the damage that is difficult to visually inspect.

### System Configuration

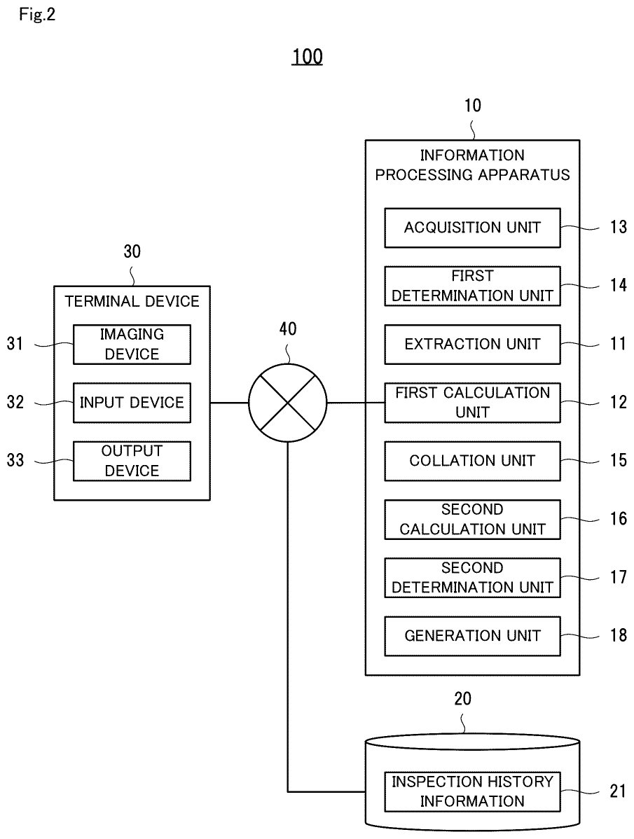

Subsequently, the configuration of the information processing apparatus 10 according to the example embodiment will be more specifically described, with reference to FIG. 2. FIG. 2 is a diagram illustrating an example of a system including the information processing apparatus. As illustrated in FIG. 2, a system 100 according to the example embodiment includes the information processing apparatus 10, a storage device 20, a terminal device 30, and a network 40.

The information processing apparatus 10 is, for example, an information processing apparatus such as a circuit, a server computer, a personal computer, or a mobile terminal equipped with a central processing unit (CPU), a programmable device such as a field-programmable gate array (FPGA), a graphics processing unit (GPU), or any one or more of these.

The storage device 20 is a database that stores a past inspection history, a server computer, a circuit having a memory, or the like. In the example of FIG. 2, the storage device 20 is provided outside the information processing apparatus 10, but may be provided inside the information processing apparatus 10.

As illustrated in FIG. 2, the storage device 20 stores inspection history information 21 and the like. The inspection history information 21 is information in which at least a past inspection image, a past inspection imaging position (two-dimensional or three-dimensional position coordinates) representing a position where the past inspection image is imaged, damage information representing a type of damage, and a position (two-dimensional or three-dimensional position coordinates) of the damaged portion representing a position of the damaged portion are associated with each other. However, information other than the inspection history information may be stored in the storage device 20.

The terminal device 30 is, for example, an information processing apparatus such as a personal computer or a mobile terminal on which a CPU, an FPGA, or both are mounted. The terminal device 30 may further include an imaging device 31, an input device 32, and an output device 33. The imaging device 31, the input device 32, and the output device 33 may be provided outside the terminal device 30.

The imaging device 31 is, for example, a camera or a device equipped with a camera and Light Detection and Ranging, Laser Imaging Detection and Ranging (LiDAR). Examples of the camera include a monocular camera (for example, a wide-angle camera, a fisheye camera, an omnidirectional camera, or the like), a compound-eye camera (for example, a stereo camera, a multi-camera, or the like), and an RGB-D camera (for example, a depth camera, a ToF camera, or the like).

The input device 32 is, for example, a device such as a touch panel, a mouse, or a keyboard.

The output device 33 obtains output information to be described later converted into a format that can be output, to output a generated image, sound, or the like based on the output information. Examples of the output device 33 include an image display device using a liquid crystal, an organic electro luminescence (EL), a cathode ray tube (CRT), or the like. Furthermore, the image display device may include, for example, an audio output device such as a speaker. The output device 33 may be a printing device such as a printer.

The network 40 is a general network constructed by using a communication line, for example, the Internet, a local area network (LAN), a dedicated line, a telephone line, an intra-company network, a mobile communication network, Bluetooth (registered trademark), Wireless Fidelity (Wi-Fi) (registered trademark), or the like.
The information processing apparatus will be described in detail.

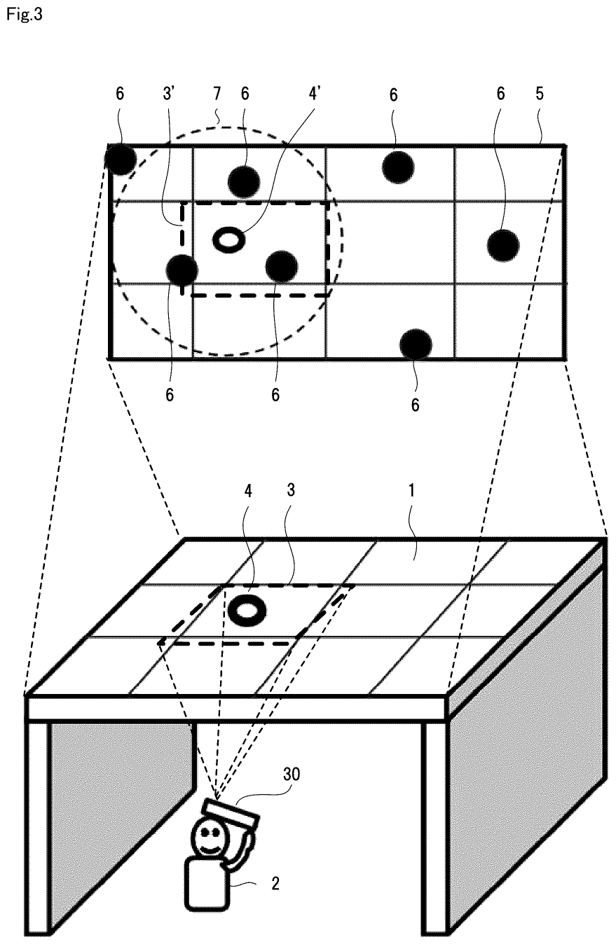

The information processing apparatus 10 will be described with reference to FIGS. 2 and 3. As illustrated in FIG. 2, the information processing apparatus 10 includes an acquisition unit 13, a first determination unit 14, an extraction unit 11, a first calculation unit 12, a collation unit 15, a second calculation unit 16, a second determination unit 17, and a generation unit 18.

FIG. 3 is a diagram for describing an example of inspection of a bridge. The lower diagram of FIG. 3 is a diagram in which an operator 2 images damage 4 of a floor slab 1 of the bridge using the terminal device 30. The upper diagram of FIG. 3 illustrates a damage diagram 5 representing damage to the floor slab 1 of the bridge.

The damage diagram 5 (or development diagram) is information generated at the time of inspection, and is a diagram in which, for example, the position of the damaged portion, the type, size, direction, and the like of the damage are recorded. The damage diagram 5 is stored in the inspection history information 21 as information.

A broken line range 3′ in FIG. 3 indicates an imaging range of the inspection image when the damage 4 is imaged. The damage image 4′ in FIG. 3 is an image (damage image) related to the damage 4. Seven black circles 6 (•) in FIG. 3 indicate the past damaged portions and positions. The structure is not limited to the floor slab 1 of the bridge.

At the time of inspecting a structure, the acquisition unit 13 acquires an inspection image (image related to 3 in FIG. 3) captured by using the imaging device 31 provided in the terminal device 30 via the network 40. The acquisition unit 13 also acquires an inspection imaging position (information indicating an inspection imaging position of a target) indicating a position where the operator 2 has imaged the inspection image. Alternatively, the damage position may be a position (two-dimensional or three-dimensional position coordinates) of the damage 4.

The inspection imaging position is, for example, position information (two-dimensional or three-dimensional position coordinates) acquired using a global positioning system (GPS) or the like. Alternatively, the inspection imaging position information may be manually set by an operator. The acquisition of the inspection imaging position is not limited to the above-described method.

The first determination unit 14 determines whether the inspection image includes a damage image that is difficult to visually inspect on the structure by using the machine learning model.

The damage to the structure includes damage that cannot be visually recognized, such as floating of concrete. Since a damage image related to damage, to the structure, that is difficult to visually inspect does not include sufficient features, it is difficult to determine whether there is damage. Therefore, using a machine learning model capable of detecting visible damage such as cracks and rust, when no damage is included in the inspection image, it is determined that the inspection image is a damage image that is difficult to visually inspect. Specifically, at the time of estimation, the first determination unit 14 inputs the inspection image to the trained machine learning model, and determines whether the inspection image is a damage image that is difficult to visually inspect.

Alternatively, the operator 2 may identify the damage, to the structure, that is difficult to visually inspect by another inspection such as a noise inspection, and manually designate the damage that is difficult to visually inspect, the damage type, or both in the inspection image of a target using the input device 32 or the like.

In a case where an image of damage, to the structure, that is difficult to visually inspect is included in an inspection image of a target, the extraction unit 11 refers to the inspection history information 21 and extracts a past inspection image (candidate image) captured in a past inspection in which a distance from an inspection imaging position (two-dimensional or three-dimensional coordinates) at which the inspection image of a target is captured to the damage position (two-dimensional or three-dimensional coordinates) is within a preset distance range 7 illustrated in FIG. 3.

The extraction unit 11 may further extract a past inspection image including the damage 4, to the structure, that is difficult to visually inspect by referring to the inspection history information 21 from the past inspection images within the distance range 7.

The position may be identified based on information in a form in which damage to either the kilometer marker or the up/down line included in the inspection history information 21 is recorded or information in a form in which damage to both is recorded. Further, when the past inspection image (candidate image) is extracted, the past inspection image may be further narrowed down using metadata (member type, digit number) associated with the past inspection image.

The first calculation unit 12 calculates a first score for each extracted past inspection image (candidate image) based on closeness of the distance. Specifically, the first calculation unit 12 calculates the reciprocal (1/L) of the distance L from the inspection imaging position to the damage position as the first score S. Alternatively, the first calculation unit 12 may calculate the first score S by multiplying (K×(1/L)) the reciprocal (1/L) of the distance L by a coefficient K set in advance for each type of damage to the structure such as floating, peeling, or a cavity, the damage being difficult to visually inspect.

Even when the target is damage, to the structure, that is difficult to visually inspect, it is possible to determine whether the past and current inspection images are captured at the identical place by using the shape of the structure included in the image, the member arrangement information, or both of them. Therefore, this coefficient may be the number of feature point pairs in which the inspection image and the past inspection image match in such a way as to be identical, for example, in the feature points extracted from shapes, member arrangements, and the like of the structures included in respective images.

In a case where the inspection image of a target includes an image of damage, to a structure, that is visible, the collation unit 15 executes matching process between the inspection image of a target and the extracted past inspection image (candidate image).

Specifically, the collation unit 15 extracts feature points of the inspection image of a target and the extracted past inspection image (candidate image). Next, collation unit 15 extracts a pair in which the feature points match each other. The above-described processing is performed for each of all the extracted past inspection images (candidate images).

As the preprocessing, the matching process may be executed after the inspection image of a target or the extracted past inspection image (candidate image) is deformed in such a way that the positions of the matching points become the same position.

As preprocessing, the inspection image generally includes an image obtained by photographing the target in a distant view in order to check the peripheral situation and an image obtained by photographing the target in a near view in order to check the details of the target. However, the past distant view image and the current distant view image may be collated first, and only in a case where the collation is successfully performed, the corresponding near view image may be collated. As a result, it is possible to reduce the collation probability at an erroneous portion such as a repetitive structure.

As the preprocessing, in a case where images other than the inspection target image appear in an inspection image of a target or an extracted past inspection image (candidate image), the matching process may be executed after masking a portion other than the inspection target image.

The second calculation unit 16 calculates the second score based on the result of the matching process. Specifically, the second calculation unit 16 sets the number of pairs of feature points in which the extracted respective past inspection images (candidate images) matching the inspection image of a target in as the second score.

In a case where the inspection image includes the damage image in which the specific member is exposed from the structure and the past inspection image related to the inspection image does not include the damage image, the second determination unit 17 sets a new abnormality flag indicating that there is a new abnormality in the inspection image (the inspection image including the damage image in which the specific member is exposed). Whether the specific member is exposed from the structure in the inspection image is determined using a machine learning model trained in advance in such a way that the specific member can be detected.

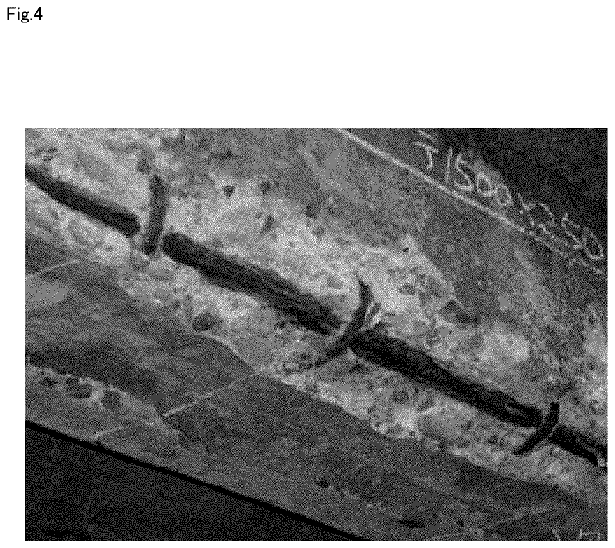

FIG. 4 is a view for describing exposure of a specific member. The example of FIG. 4 is a view illustrating that a reinforcing bar is exposed from concrete. Since the method of handling the specific member changes depending on the progress of the damage, there is a case where it is necessary to count the specific member as a new abnormality depending on the degree of damage even in the same portion. For example, the concrete progresses from the peeling to the exposure of the reinforcing bar due to the progress of abnormality, and, in the case of peeling, an operation such as knocking down is performed in order to prevent further falling off. On the other hand, when the reinforcing bar is exposed, repair for preventing corrosion of the reinforcing bar is required.

In the case of damage, to the structure, that is difficult to visually inspect, the generation unit 18 generates output information for causing the output device 33 to output an output in which the extracted past inspection image (candidate image) is associated with the first score. Next, the generation unit 18 transmits the output information to the terminal device 30. Thereafter, the terminal device 30 receives the output information, and displays an inspection image 51, the extracted past inspection image (candidate image), and the first score on the output device 33 (monitor) of the terminal device 30.

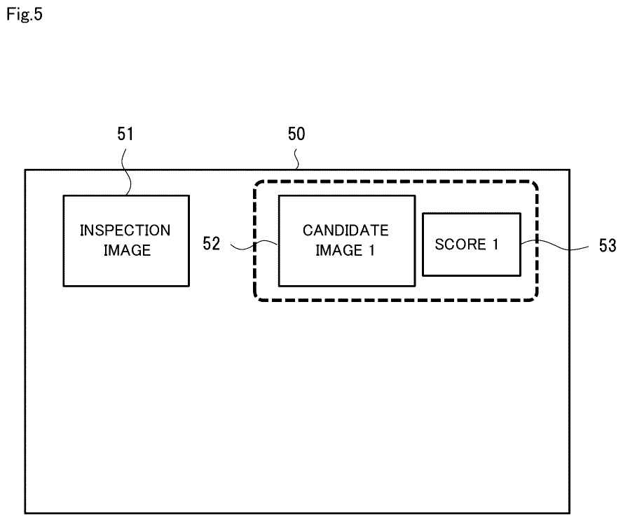

FIG. 5 is a diagram for describing an example of display of scores in the case of damage, to the structure, that is difficult to visually inspect. Specifically, as illustrated in FIG. 5, an inspection image 51, an extracted past inspection image 52 (candidate image), and a first score 53 are displayed on a user interface 50 of the output device 33 (monitor). However, the number of candidate images is not limited to one.

In the case of damage, to a structure, that can be visually inspected, the generation unit 18 generates output information for causing the output device 33 to output an output in which a past inspection image (candidate image) having a high second score is associated with the second score. Next, the generation unit 18 transmits the output information to the terminal device 30. Thereafter, the terminal device 30 receives the output information, and displays the inspection image, the extracted past inspection image (candidate image), and the second score on the output device 33 (monitor) of the terminal device 30.

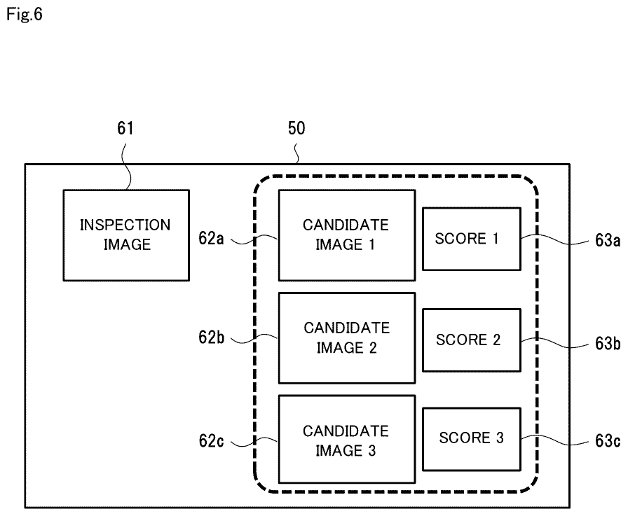

FIG. 6 is a diagram for describing an example of display of scores in the case of damage, to a structure, that can be visually inspected. Specifically, as illustrated in FIG. 6, an inspection image 61, extracted past inspection images (candidate images) 62a, 62b, and 62c, and second scores 63a, 63b, and 63c are displayed on the user interface 50 of the output device 33 (monitor). However, the number of candidate images is not limited to three.

In a case where all the second scores are equal to or less than a preset threshold value, the second score may not be displayed. Specifically, a message such as “there is no corresponding past inspection image” may be displayed.

In addition to the score, in order to make it easy to visually understand identical-location determination, a candidate image having the consistent angle of view may be displayed by a homography transformation using matching points.

The coordinates of the candidate image on the structure, the damage type name, and the like may be displayed. As a result, the operator can easily identify the current inspection image and the past inspection image based on information other than the image.

### Apparatus Operation

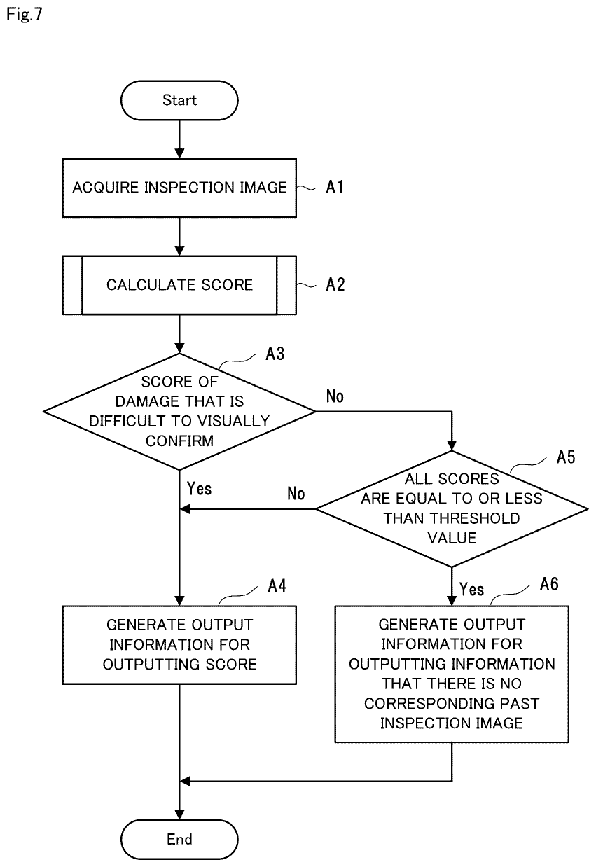

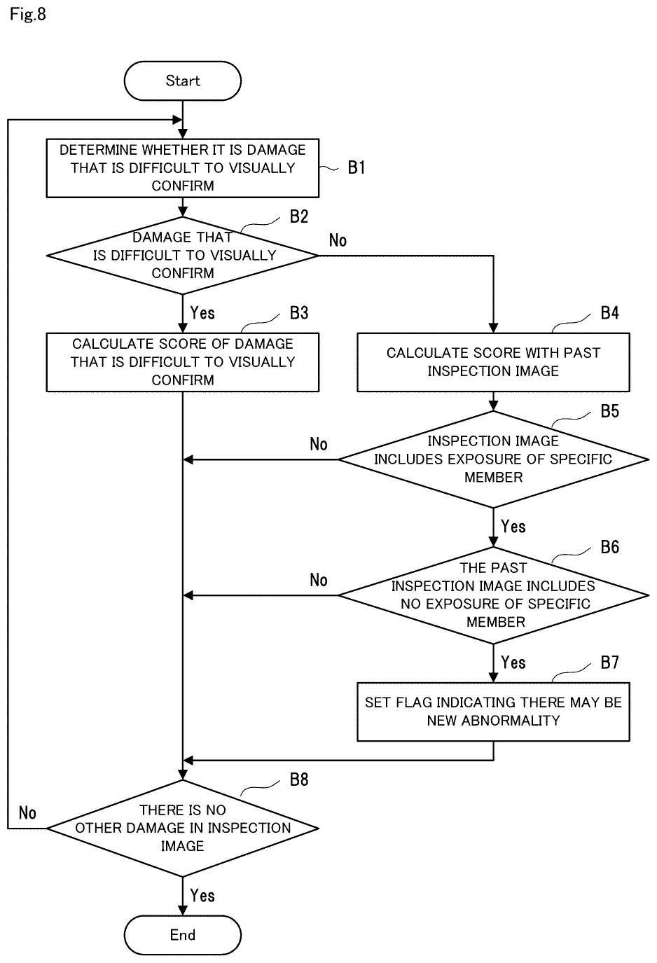

Next, an operation of the information processing apparatus according to the example embodiment will be described with reference to FIGS. 7 and 8. FIGS. 7 and 8 are diagrams for describing an example of the operation of the information processing apparatus. The drawings will be appropriately referred to in the following description. In the example embodiment, by operating the information processing apparatus, an information processing method is implemented. Therefore, description of the information processing method according to the example embodiment is substituted with the description of the operation of the information processing apparatus below.

As illustrated in FIG. 7, first, at the time of inspecting a structure, the acquisition unit 13 acquires an inspection image captured using the imaging device 31 provided in the terminal device 30 via the network 40 (step A1). Next, a score is calculated (step A2). Step A2 will be described in detail with reference to FIG. 8.

As illustrated in FIG. 8, in the calculation of the score, first, the first determination unit 14 determines whether there is a damage image, of the structure, that is difficult to visually inspect in the inspection image by using the machine learning model (step B1).

Next, in a case where the inspection image of a target includes an image of damage, to the structure, that is difficult to visually inspect (step B2: Yes), a score of damage that is difficult to visually confirm is calculated (step B3).

Specifically, in step B3, first, the extraction unit 11 refers to the inspection history information 21, and extracts a past inspection image (candidate image) captured in a past inspection in which a distance from an inspection imaging position where an inspection image of a target is captured or a damage position (two-dimensional or three-dimensional coordinates) of the target to a past damage position (two-dimensional or three-dimensional coordinates) is within a preset distance range 7.

In step B3, the extraction unit 11 may further extract a past inspection image including the damage 4, to the structure, that is difficult to visually inspect by referring to the inspection history information 21 from the past inspection images within the distance range 7.

Next, in step B3, the first calculation unit 12 calculates the first score for each extracted past inspection image (candidate image) based on the closeness of the distance. Specifically, the first calculation unit 12 calculates the reciprocal (1/L) of the distance L from the inspection imaging position to the damage position as the first score S. Alternatively, the first calculation unit 12 may calculate the first score S by multiplying (K×(1/L)) the reciprocal (1/L) of the distance L by a coefficient K set in advance for each type of damage, to the structure, that is difficult to visually inspect.

Next, in a case where an image of damage, to the structure, that is visible is included in the inspection image of a target (Step B2: No), the extraction unit 11 calculates a score with the past inspection image (step B4).

Specifically, in step B4, first, in a case where an image of damage, to the structure, that is visible is included in the inspection image of a target, the collation unit 15 executes the matching process between an inspection image of a target and the extracted past inspection image (candidate image).

Specifically, the collation unit 15 extracts feature points of the inspection image of a target and the extracted past inspection image (candidate image). Next, collation unit 15 extracts a pair in which the feature points match each other. The above-described processing is performed for each of all the extracted past inspection images (candidate images).

Next, in step B4, the second calculation unit 16 calculates the second score based on the result of the matching process. Specifically, the second calculation unit 16 sets the number of pairs of the respective extracted past inspection images (candidate images) as the second score.

Next, in a case where the inspection image includes the damage image in which the specific member is exposed from the structure (step B5: Yes) and the past inspection image related to the inspection image does not include the damage image (step B6: Yes), the second determination unit 17 sets a new abnormality flag indicating that there is a new abnormality in the inspection image (the inspection image including the damage image in which the specific member is exposed) (step B7).

Next, in a case where there is no other damage in the inspection image (step B8: Yes), the process ends, and the process proceeds to Step A3 of FIG. 7. In a case where there is another damage in the inspection image (step B8: No), the process proceeds to step B1.

Next, in a case of the first score of the damage that is difficult to visually confirm (step A3: Yes), the generation unit 18 generates output information for causing the output device 33 to output an output in which the extracted past inspection image (candidate image) and the first score are associated with each other in a case where the damage is damage, to the structure, that is difficult to visually inspect (step A4). Thereafter, in step A4, the generation unit 18 transmits the output information to the terminal device 30. The terminal device 30 receives the output information, and displays the inspection image 51, the extracted past inspection image (candidate image), and the first score on the output device 33 (monitor) of the terminal device 30.

In a case of the damage, to the structure, that can be visually inspected (step A3: No), and in a case where all the second scores are equal to or less than a preset threshold value (step A5: Yes), output information for outputting information that there is no corresponding past inspection image is generated (step A6). Thereafter, in step A6, the generation unit 18 transmits the output information to the terminal device 30. The terminal device 30 may receive the output information and display “there is no corresponding past inspection image” or the like on the output device 33 (monitor) of the terminal device 30.

In a case of the damage of the structure that can be visually inspected (step A3: No), and in a case where the second score exceeds a preset threshold value (step A5: No), the generation unit 18 generates output information for causing the output device 33 to output an output in which a past inspection image (candidate image) having a high second score is associated with the second score. Thereafter, in step A4, the generation unit 18 transmits the output information to the terminal device 30. The terminal device 30 receives the output information, and displays the inspection image, the extracted past inspection image (candidate image), and the second score on the output device 33 (monitor) of the terminal device 30.

Further, in a case where the specific member is exposed from the structure in the inspection image, a display indicating that there is a new abnormality may be performed in the inspection image (the inspection image including the damage image in which the specific member is exposed).

### Effects of Example Embodiment

As described above, according to the example embodiment, by presenting the first score of each of the extracted past inspection images (candidate images) to the operator, it is possible to support inspection in such a way as to be able to perform efficient inspection even for the damage that is difficult to visually inspect. Specifically, association with the past inspection result can be efficiently performed.

By presenting the second score of each of the extracted past inspection images (candidate images) to the operator, it is possible to support inspection in such a way as to be able to perform efficient inspection in such a way that the inspection can be efficiently performed even for the damage that can be visually inspected.

In a case where the specific member is exposed from the structure in the inspection image, it is possible to support inspection in such a way as to be able to perform efficient inspection by indicating that there is a new abnormality in the inspection image (the inspection image including the damage image in which the specific member is exposed).

### Program

The program in the example embodiment may be a program that causes a computer to execute steps A1 to A6 and B1 to B8 illustrated in FIGS. 7 and 8. When the program is installed in the computer and executed, the information processing apparatus and the information processing method according to the example embodiment can be achieved. In this case, the processor of the computer functions as the acquisition unit 13, the first determination unit 14, the extraction unit 11, the first calculation unit 12, the collation unit 15, the second calculation unit 16, the second determination unit 17, and the generation unit 18, and performs processing.

The program in the example embodiment may be executed by a computer system including a plurality of computers. In this case, for example, each computer may function as any of the acquisition unit 13, the first determination unit 14, the extraction unit 11, the first calculation unit 12, the collation unit 15, the second calculation unit 16, the second determination unit 17, and the generation unit 18.

### Physical Configuration

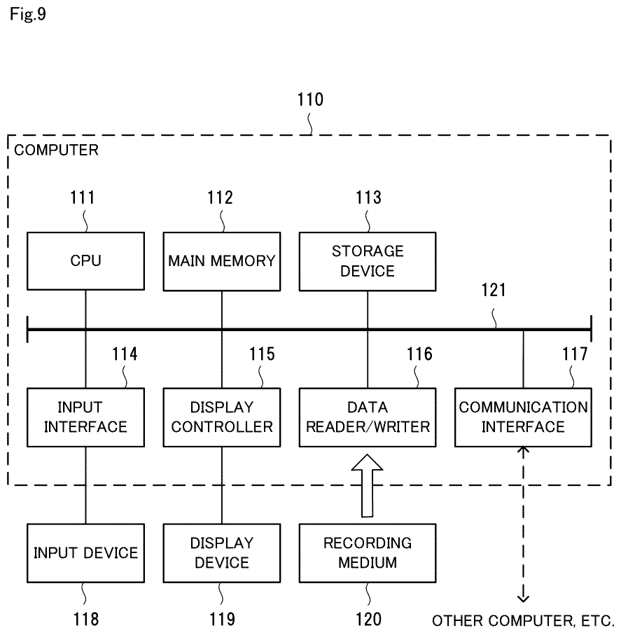

The computer that achieves the information processing apparatus by executing the program in the example embodiment will be described with reference to FIG. 9. FIG. 9 is a diagram for describing an example of a computer that achieves the information processing apparatus according to an example embodiment.

As illustrated in FIG. 9, a computer 110 includes a central processing unit (CPU) 111, a main memory 112, a storage device 113, an input interface 114, a display controller 115, a data reader/writer 116, and a communication interface 117. These units are connected via a bus 121 in such a way as to be able to perform data communication with each other. The computer 110 may include a GPU or an FPGA in addition to the CPU 111 or instead of the CPU 111.

The CPU 111 loads the program in the example embodiments, the program being stored in the storage device 113 and constituted by codes, into the main memory 112, and executes the codes in a predetermined order to perform various computations. The main memory 112 is typically a volatile storage device such as a dynamic random access memory (DRAM).

The program in the example embodiment is provided in a state of being stored in a computer-readable recording medium 120. The program in the example embodiment may be distributed on the Internet connected via the communication interface 117.

Specific examples of the storage device 113 include a semiconductor storage device, such as a flash memory, in addition to a hard disk drive. The input interface 114 mediates data transmission between the CPU 111 and an input device 118 such as a keyboard and a mouse. The display controller 115 is connected to a display device 119, and controls display on the display device 119.

The data reader/writer 116 mediates data transmission between the CPU 111 and the recording medium 120, and reads a program from the recording medium 120 and writes a processing result in the computer 110 into the recording medium 120. The communication interface 117 mediates data transmission between the CPU 111 and another computer.

Specific examples of the recording medium 120 include a general-purpose semiconductor storage device such as Compact Flash (CF) (registered trademark) or Secure Digital (SD), a magnetic recording medium such as a flexible disk, and an optical recording medium such as a compact disk read only memory (CD-ROM).

The information processing apparatus 10 in the example embodiment can also be achieved using hardware related to each unit, for example, an electronic circuit, instead of a computer in which a program is installed. Moreover, part of the information processing apparatus 10 may be achieved by a program, and the remaining part may be achieved by hardware. In the example embodiments, the computer is not limited to the computer illustrated in FIG. 9.

### Supplementary Note

With regard to the above example embodiment, the following Supplementary Notes are further disclosed. A part or whole of the example embodiment described above may be expressed by the following (Supplementary Note 1) to (Supplementary Note 27), but is not limited to the following description.

### Supplementary Note 1

An information processing apparatus including
an extraction unit for referring, in a case where an inspection image of a target includes an image of damage, to a structure, that is difficult to visually inspect, to a damage position included in inspection history information in which a past inspection history is stored, and extracting a past inspection image captured in a past inspection in which a distance from a position where the inspection image is captured or an inspection imaging position representing a damage position of the target to a past damage position is within a distance range set in advance, and
a first calculation unit for calculating a first score based on closeness of the distance for the extracted past inspection image.

### Supplementary Note 2

The information processing apparatus according to Supplementary Note 1, further including a generation unit for generating output information for causing an output device to display an output in which the extracted past inspection image and the first score are associated with each other.

### Supplementary Note 3

The information processing apparatus according to Supplementary Note 1, wherein the extraction unit further refers to the inspection history information to extract a past inspection image including an image of damage, to the structure, that is difficult to visually inspect, from the past inspection images within a distance range.

### Supplementary Note 4

The information processing apparatus according to Supplementary Note 1, wherein the first calculation unit calculates a reciprocal of a distance from the inspection imaging position to the damage position as the first score.

### Supplementary Note 5

The information processing apparatus according to Supplementary Note 4, wherein the first calculation unit calculates the first score by multiplying a reciprocal of the distance by a coefficient set in advance for each type of the damage, to the structure, that is difficult to visually inspect.

### Supplementary Note 6

The information processing apparatus according to Supplementary Note 4, wherein the first calculation unit calculates the first score by multiplying a reciprocal of the distance by the number of feature point pairs, as a coefficient, in which the inspection image and the past inspection image match in such a way as to be identical in feature points on the images extracted based on shapes or member arrangements of structures in respective images, or both of the shape and the member arrangement.

### Supplementary Note 7

The information processing apparatus according to Supplementary Note 1, further including a determination unit for determining whether the inspection image includes the damage, to the structure, that is difficult to visually inspect by using a machine learning model.

### Supplementary Note 8

The information processing apparatus according to Supplementary Note 2, further including a collation unit for executing a matching process between the inspection image and a past inspection image captured in a past inspection in a case where the inspection image of the target includes an image of damage, to a structure, that is visible, and a second calculation unit for calculating a second score based on a result of the matching process, wherein the generation unit generates output information for causing an output device to output an output in which the past inspection image having the high second score is associated with the second score.

### Supplementary Note 9

The information processing apparatus according to Supplementary Note 1, wherein in a case where the inspection image includes a damage image in which a specific member is exposed from the structure and a past inspection image related to the inspection image does not include the damage image, a new abnormality flag indicating that there is a new abnormality is set in the inspection image.

### Supplementary Note 10

An information processing method executed by a computer, the method including
referring, in a case where an inspection image of a target includes an image of damage, to a structure, that is difficult to visually inspect, to a damage position included in inspection history information in which a past inspection history is stored, and extracting a past inspection image captured in a past inspection in which a distance from a position where the inspection image is captured or an inspection imaging position representing a damage position of the target to a past damage position is within a distance range set in advance,
calculating a first score based on closeness of the distance for the extracted past inspection image, and
generating display information for causing a display device to display a display in which the extracted past inspection image and the first score are associated with each other.

### Supplementary Note 11

The information processing method executed by the computer according to Supplementary Note 10, the method further including generating output information for causing an output device to display an output in which the extracted past inspection image and the first score are associated with each other.

### Supplementary Note 12

The information processing method executed by the computer according to Supplementary Note 10, the method further including referring to the inspection history information among the past inspection images within a distance range and extracting a past inspection image including an image of damage to the structure that is difficult to visually inspect.

### Supplementary Note 13

The information processing method executed by the computer according to Supplementary Note 10, the method further including calculating a reciprocal of a distance from the inspection imaging position to the damage position as the first score.

### Supplementary Note 14

The information processing method executed by the computer according to Supplementary Note 13, the method further including calculating the first score by multiplying a reciprocal of the distance by a coefficient set in advance for each type of the damage, to the structure, that is difficult to visually inspect.

### Supplementary Note 15

The information processing method executed by the computer according to Supplementary Note 13, the method further including calculating the first score by multiplying a reciprocal of the distance by the number of feature point pairs, as a coefficient, in which the inspection image and the past inspection image match in such a way as to be identical in feature points on the images extracted based on shapes or member arrangements of structures in respective images, or both of the shapes and the member arrangements.

### Supplementary Note 16

The information processing method executed by the computer according to Supplementary Note 10, the method further including determining whether the inspection image includes the damage, to the structure, that is difficult to visually inspect by using a machine learning model.

### Supplementary Note 17

The information processing method executed by the computer according to Supplementary Note 11, the method further including
executing a matching process between the inspection image and a past inspection image captured in a past inspection in a case where the inspection image of the target includes an image of damage, to a structure, that is visible, and
calculating a second score based on a result of the matching process,
wherein the generation unit generates output information for causing an output device to output an output in which the past inspection image having the high second score is associated with the second score.

### Supplementary Note 18

The information processing method executed by the computer according to Supplementary Note 10, the method further including in a case where the inspection image includes a damage image in which a specific member is exposed from the structure and a past inspection image related to the inspection image does not include the damage image, setting a new abnormality flag indicating that there is a new abnormality in the inspection image.

### Supplementary Note 19

A computer-readable recording medium recording a program for causing a computer to execute the steps of
referring, in a case where an inspection image of a target includes an image of damage, to a structure, that is difficult to visually inspect, to a damage position included in inspection history information in which a past inspection history is stored, and extracting a past inspection image captured in a past inspection in which a distance from a position where the inspection image is captured or an inspection imaging position representing a damage position of the target to a past damage position is within a distance range set in advance,
calculating a first score based on closeness of the distance for the extracted past inspection image, and
generating display information for causing a display device to display a display in which the extracted past inspection image and the first score are associated with each other.

### Supplementary Note 20

The computer-readable recording medium according to Supplementary Note 19 recording a program for causing a computer to execute the step of generating output information for causing an output device to display an output in which the extracted past inspection image and the first score are associated with each other.

### Supplementary Note 21

The computer-readable recording medium according to Supplementary Note 19 recording a program for causing the computer to execute the step of further referring to the inspection history information among the past inspection images within a distance range and extracting a past inspection image including an image of damage to the structure that is difficult to visually inspect.

### Supplementary Note 22

The computer-readable recording medium according to Supplementary Note 21 recording a program for causing the computer to execute the step of calculating a reciprocal of a distance from the inspection imaging position to the damage position as the first score.

### Supplementary Note 23

The computer-readable recording medium according to Supplementary Note 22 recording a program for causing the computer to execute the step of calculating the first score by multiplying a reciprocal of the distance by a coefficient set in advance for each type of damage to the structure that is difficult to visually inspect.

### Supplementary Note 24

The computer-readable recording medium according to Supplementary Note 22 recording a program for causing the computer to execute the step of calculating the first score by multiplying the reciprocal of the distance by a coefficient that is the number of feature point pairs in which the inspection image and the past inspection image match in such a way as to be identical in feature points on the images extracted based on shapes or member arrangements of structures in respective images, or both of the shapes and the member arrangements.

### Supplementary Note 25

The computer-readable recording medium according to Supplementary Note 19 recording a program for causing the computer to execute the step of determining, by using a machine learning model, whether the inspection image includes damage to the structure that is difficult to visually inspect.

### Supplementary Note 26

The computer-readable recording medium according to Supplementary Note 20 recording a program for causing the computer to execute the steps of
executing a matching process between the inspection image and a past inspection image captured in a past inspection in a case where the inspection image of the target includes an image of damage, to a structure, that is visible, and
calculating a second score based on a result of the matching process,
wherein the generation unit generates output information for causing an output device to output an output in which the past inspection image having the high second score is associated with the second score.

### Supplementary Note 27

The computer-readable recording medium according to Supplementary Note 19 recording a program for causing the computer to execute the step of, in a case where the inspection image includes a damage image in which a specific member is exposed from the structure and a past inspection image related to the inspection image does not include the damage image, setting a new abnormality flag indicating that there is a new abnormality in the inspection image.

While the invention has been particularly shown and described with reference to example embodiments thereof, the invention is not limited to these example embodiments. It will be understood by those of ordinary skill in the art that various changes in form and details may be made therein without departing from the spirit and scope of the invention as defined by the claims.

### INDUSTRIAL APPLICABILITY

According to the above description, it is possible to support inspection in such a way as to be able to perform efficient inspection even for the damage that is difficult to visually inspect. It is useful in a field where inspection of a structure is necessary.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

1. An information processing apparatus comprising:
at least one memory storing instructions; and
at least one processor configured to execute the instructions to:
refer, in a case where an inspection image of a target includes an image of damage, to a structure, that is difficult to visually inspect, to a damage position included in inspection history information in which a past inspection history is stored, and extract a past inspection image captured in a past inspection in which a distance from a position where the inspection image is captured or an inspection imaging position representing a damage position of the target to a past damage position is within a distance range set in advance; and
calculate a first score based on closeness of the distance for the extracted past inspection image.

2. The information processing apparatus according to claim 1,
wherein the one or more processors further:
generates output information for causing an output device to display an output in which the extracted past inspection image and the first score are associated with each other.

3. The information processing apparatus according to claim 1,
wherein the one or more processors further:
calculates a reciprocal of a distance from the inspection imaging position to the damage position as the first score.

4. The information processing apparatus according to claim 1,
wherein the one or more processors further:
calculates the first score by multiplying a reciprocal of the distance by a coefficient set in advance for each type of the damage, to the structure, that is difficult to visually inspect.

5. The information processing apparatus according to claim 4,
wherein the one or more processors further:
calculates the first score by multiplying a reciprocal of the distance by the number of feature point pairs, as a coefficient, in which the inspection image and the past inspection image match in such a way as to be identical in feature points on the images extracted based on shapes or member arrangements of structures in respective images or both of the shapes and the member arrangements.

6. The information processing apparatus according to claim 1,
wherein the one or more processors further:
determines whether the inspection image includes the damage, to the structure, that is difficult to visually inspect by using a machine learning model.

7. The information processing apparatus according to claim 2,
wherein the one or more processors further:
executes a matching process between the inspection image and a past inspection image captured in a past inspection in a case where the inspection image of the target includes an image of damage, to a structure, that is visible; and
calculates a second score based on a result of the matching process,
wherein generates output information for causing an output device to output an output in which the past inspection image having the high second score is associated with the second score.

8. The information processing apparatus according to claim 1,
wherein the one or more processors further:
in a case where the inspection image includes a damage image in which a specific member is exposed from the structure and a past inspection image related to the inspection image does not include the damage image, a new abnormality flag indicating that there is a new abnormality set in the inspection image.

9. An information processing method executed by a computer, the method comprising:
referring, in a case where an inspection image of a target includes an image of damage, to a structure, that is difficult to visually inspect, to a damage position included in inspection history information in which a past inspection history is stored, and extracting a past inspection image captured in a past inspection in which a distance from a position where the inspection image is captured or an inspection imaging position representing a damage position of the target to a past damage position is within a distance range set in advance;
calculating a first score based on closeness of the distance for the extracted past inspection image; and
generating display information for causing a display device to display a display in which the extracted past inspection image and the first score are associated with each other.

10. A non-transitory computer-readable recording medium recording a program for causing a computer to execute the steps of:
referring, in a case where an inspection image of a target includes an image of damage, to a structure, that is difficult to visually inspect, to a damage position included in inspection history information in which a past inspection history is stored, and extracting a past inspection image captured in a past inspection in which a distance from a position where the inspection image is captured or an inspection imaging position representing a damage position of the target to a past damage position is within a distance range set in advance;
calculating a first score based on closeness of the distance for the extracted past inspection image; and
generating display information for causing a display device to display a display in which the extracted past inspection image and the first score are associated with each other.
